(19) United States
(12) Patent Application Publication
(10) Pub. No.: US 2012/0281186 A1
(43) Pub. Date: Nov. 8, 2012

(54) LASER PROJECTION SYSTEM

(75) Inventor: CHIEN-CHIH HSIUNG, TAICHUNG (TW)

(73) Assignee: ASIA OPTICAL CO., INC., TAICHUNG (TW)

(21) Appl. No.: 13/446,990

(22) Filed: Apr. 13, 2012

(30) Foreign Application Priority Data
May 5, 2011 (TW) 100115859

(51) Int. Cl. G03B 21/14

(52) U.S. Cl. 353/31

(57) ABSTRACT

A laser projection system includes a laser module, a red, a green, and a blue fluorescent member, three collimators, a prism, and a scan system lens. The laser module emits laser beam of single wavelength. The red, green, and blue fluorescent members are excited by the laser beam from the laser module to emit red beam, green beam, and blue beam respectively. The collimators are on paths of the red, green, and blue beams respectively to collimate them. The prism reflects the collimated red, green, and blue beams to project them onto an imaging surface through the scan system lens.

### BACKGROUND OF THE INVENTION

1. Field of the Invention

The present invention relates generally to a laser projection system, and more particularly, to a laser projection system that uses single wavelength laser beam.

2. Description of the Related Art

Typically, conventional projectors are equipped with a halogen lamp or an arc lamp to emit light. Such light source may emit high brightness light, however, it has some drawbacks, including high power needed, high temperature, short life, and high cost. Such projector needs a radiator to dissipate the heat of the lamp that the projector usually is huge and heavy. In recent days, laser is used in the projectors. Laser projectors usually have a simple structure and a fine color reproduction. Because of no need of radiator in the laser projector, the laser projector may be smaller and lighter than the conventional halogen lamp projector. In conclusion, the laser projector, compared with the halogen lamp projector, is smaller, lighter, and has an image with better color reproduction.

In conventional projection system, it needs three primary color lights to project a full color image. Therefore, red laser, blue laser, and green laser are provided in the laser projector to emit red, blue, and green laser beams. Three laser devices take lots of space in the projector, and they need many complex processes, such as conversion of intensity distribution, light combination, optical harmonization, speckle elimination, beam-splitting, and diffraction grating. It is necessary to develop a projection with single wavelength laser.

### SUMMARY OF THE INVENTION

The primary objective of the present invention is to provide a laser projection system, which emits single wavelength laser beam to simplify the laser module, reduce the size, and lower the cost.

According to the objective of the present invention, a laser projection system includes a laser module, a red, a green, and a blue fluorescent member, three collimators, a prism, and a scan system lens. The laser module emits laser beam of single wavelength. The red, green, and blue fluorescent members are excited by the laser beam from the laser module to emit red beam, green beam, and blue beam respectively. The collimators are on paths of the red, green, and blue beams respectively to collimate them. The prism reflects the collimated red, green, and blue beams to project them onto an imaging surface through the scan system lens.

### BRIEF DESCRIPTION OF THE DRAWINGS

FIG. 1 is a block diagram of a preferred embodiment of the present invention.

### DETAILED DESCRIPTION OF THE INVENTION

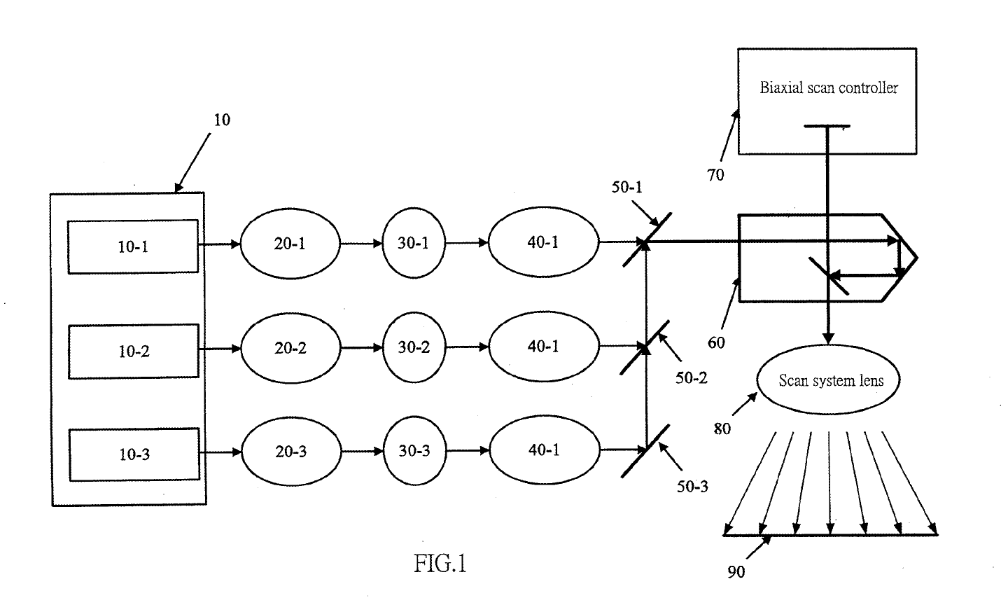

As shown in FIG. 1, a laser projection system of the preferred embodiment of the present invention includes a laser module 10, a collimator 20-1, a collimator 20-2, a collimator 20-3, a red fluorescent member 30-1, a green fluorescent member 30-2, a blue fluorescent member 30-3, a first collimator 40-1, a second collimator 40-2, a third collimator 40-3, a first lens 50-1, a second lens 50-2, a third lens 50-3, a prism 60, a biaxial scan controller 70, and a scan system lens 80.

The laser module 10 includes three single wavelength laser devices 10-1, 10-2, and 10-3 associated with the red fluorescent member 30-1, the green fluorescent member 30-2, and the blue fluorescent member 30-3 respectively. In the present invention, a collimator (not shown) is provided between each pair of the laser device 10-1, 10-2, and 10-3 and the fluorescent member 30-1, 30-2, and 30-3 to collimate the laser beams from the laser devices 10-1, 10-2, and 10-3.

The collimated laser beams from the laser devices 10-1, 10-2, and 10-3 excite the red, green, and blue fluorescent members 30-1, 30-2, and 30-3 respectively to emit a red beam, a green beam, and a blue beam with a specific wavelength.

The red, green, and blue beams emit to the first, second, and third collimators 40-1, 40-2, and 40-3 respectively to be collimated again to project a collimated red beam, a collimated green beam, and a collimated blue beam. Next, the red beam emit through the first lens 50-1, the green beam is reflected by the second lens 50-2 and is reflected again by the first lens 50-1, and the blue beam is reflected by the third lens 50-3, emits through the second lens 50-2, and is reflected again by the first lens 50-1 that the red, green, and a blue beam emit to the prism 60. The above arrangement of the lenses is just an example of changing the paths of the beams of the present invention. Any design of the lenses to reflect the beams to the prism 60 is still in the scope of the present invention.

The prism 60 reflects the red, green, and blue beams from the lenses 50-1, 50-2, and 50-3 to the scan system lens 80. The scan system lens 80 projects the beams onto an imaging surface 90, such as a screen. The biaxial scan controller 70 of the present invention controls the scan system lens 80 by mechanical means or electronic means to change the paths of the beams to the imaging surface 90 that the projection system of the present invention may project an image onto the imaging surface 90 according to image signals from other device.

The present invention uses single wavelength laser, such as ultraviolet, that the projection system of the present invention doesn't have the drawbacks of the conventional projector with halogen lamp. The projection system of the present invention has a simple structure, fewer components, and a lower cost. Because of simple structure, higher color reproduction, the projection system of the present invention may provide high quality images.

The description above is a few preferred embodiments of the present invention, and the equivalence of the present invention is still in the scope of claim construction of the present invention.

What is claimed is:

1. A laser projection system, comprising:
a laser module having at least a laser device to emit single wavelength laser beam;
a red fluorescent member excited by the laser beam from the laser module to emit a red beam;
a green fluorescent member excited by the laser beam from the laser module to emit a green beam;
a blue fluorescent member excited by the laser beam from the laser module to emit a blue beam;
a first collimator on a path of the red beam from the red fluorescent member to collimate the red beam;
a second collimator on a path of the green beam from the green fluorescent member to collimate the green beam;
a third collimator on a path of the blue beam from the blue fluorescent member to collimate the blue beam;
a prism receiving the collimated beams from the first collimator, the second collimator, and the third collimator to reflect the red beams, the green beam, and the blue beam respectively; and
a scan system lens projecting the red beams, the green beam, and the blue beam from the prism onto an image surface to form an image.

2. The laser projection system as defined in claim 1, further comprising at least a collimator between the laser module and the fluorescent members to collimate the laser beam from the laser module.

3. The laser projection system as defined in claim 1, further comprising a biaxial scan controller which controls the scan system lens to change paths of the red beam, the green beam, and the blue beam projecting onto the imaging surface.

4. The laser projection system as defined in claim 1, further comprising a first lens between the fluorescent members and the prism to pass the red beam therethrough and reflect the green beam and the blue beam.

5. The laser projection system as defined in claim 1, further comprising a second lens between the fluorescent members and the prism to pass the blue beam therethrough and reflect the green beam.

6. The laser projection system as defined in claim 1, further comprising a second lens between the blue fluorescent member and the prism to reflect the blue beam.

7. The laser projection system as defined in claim 1, wherein the single wavelength laser beam is ultraviolet.
